(19) United States
(12) Patent Application Publication
(10) Pub. No.: US 2006/0180093 A1
(43) Pub. Date: Aug. 17, 2006

(54) Animal control system

(75) Inventors: Peter Stephen Cross, Hamilton (NZ); Rodney Wayne Claycomb, Hamilton (NZ)

Correspondence Address: LOWE HAUPTMAN BERNER, LLP, 1700 DIAGONAL ROAD, SUITE 300, ALEXANDRIA, VA, 22314, US

(73) Assignee: Sensortec Limited, Hamilton (NZ)

(21) Appl. No.: 10/543,616

(22) PCT Filed: Jan. 30, 2004
(86) PCT No.: PCT/NZ04/00015

§ 371 Date: Feb. 17, 2006

(30) Foreign Application Priority Data
Jan. 30, 2003 (NZ) 523948

(51) Int. Cl. A01K 15/02

(52) U.S. Cl. 119/720

(57) ABSTRACT

An animal control system, including at least one transducer assembly intimately associated with an animal, and at least one control unit, wherein the control unit contains at least one assembly that includes on-board data, and the control unit is configured to receive data from the transducer assembly, and assess the received data with respect to the on-board data, and formulate and transmit a command to an appropriate transducer assembly; the system wherein the control unit is functionally separated from both actuation of the command and from the transducer assembly or assemblies.

### TECHNICAL FIELD

This invention relates to an animal control system.

In particular, this invention preferably relates to an automatic animal control system for the controlling of animals both locally and remotely.

Reference throughout this specification should now be made to use that the present invention is for controlling domesticated animals such as cattle, sheep and deer, although it should be appreciated that the present invention can be applied to other animals.

### BACKGROUND ART

Animal control apparatus for the sorting of animals and for the controlling of the flow of a herd of animals are well known within the animal husbandry industry.

These systems mainly provide methods of controlling the drafting of animals or for controlling the movement of animals within milking parlours and such like.

The drafting systems currently available range from the very basic passageway which leads the animals from one area to another, to complex systems involving a number of gates and linked to various animal identification systems.

The basic drafting system which is a passageway with an entry and an exit has many limitations in that it cannot sort between animals and only assists the animals in moving from one location to another desired location.

There have been many improvements over time with the introduction of more than one exit, each of which are blocked by a gate until the appropriate gate is opened by one means or another.

The earlier systems employed a manual gating system whereby the person controlling the flow of the animals would need to identify which exit was required by which animal and open and close the appropriate gates.

There are a number of obvious drawbacks with this system in that not only does an operator have to be situated at a convenient point to the gates but the operator must also check and identify each animal individually in order to ascertain which exit is most appropriate for which animal.

Drafting apparatus containing more than one exit were introduced in order that animals can be separated from within a group as there are a number of reasons why this would be desirable.

Examples of these reasons would be to separate animals that are in oestrus, have been injured, are in a holding period due to the presence of medicaments in the animals system, in order that the particular animal can be more closely examined etc.

As stated previously various methods have been tried to improve the separation process in order to not only make it more efficient, but also to make it at least partially automatic.

One attempt at overcoming the problems with the manual systems was disclosed in New Zealand Patent No. 268584 wherein the main passageway contained two animal identification systems which determine which exit an animal is required to go through and keep that exit open until an animal approaches which is required to leave through a different exit. At this point a set of stop gates close across the passageway until the appropriate exit can be opened and all inappropriate exits can be closed.

Whilst this overcomes a lot of the problems associated with the previous systems it does however have some major drawbacks in that the system is quite slow, particularly when the sorting gates are closed as at this point the animals within the raceway will back up forming a blockage with more than one animal identification being recognised by the system and this in turn can cause the system to crash if animals that need to exit from more than one exit are identified at the same time.

Improvements over this system include those systems disclosed in New Zealand Patent No's. 314425 and 330164.

These two systems again use a method for identifying an individual animal electronically and having read the information from the transponder on the animal the system determines which exit the animal is required to leave through and the appropriate gateway is opened. As an animal approaches the gateway a second unit detects the animal's presence and initiates the closing of the gate.

Whilst these systems overcome a lot of the problems associated with the apparatus of New Zealand Patent No. 268584 they still have significant drawbacks.

Not only are these systems limited to being in close proximity to the animal identification unit that reads information from the transponder on the animal, it must also be in an enclosed raceway to ensure that one animal cannot under any circumstances proceed past a previously identified animal.

These systems are also severely limited in their abilities as they merely check against a look-up table as to which exit is logged as being the one for each particular animal.

One major problem associated with this type of system can occur in situations where the sorting of animals is required at a remote location from the main control unit as it is seldom possible to ensure that animals proceed in an orderly fashion for any distance without attempting to at least pass one other animal. This therefore means that animals can approach remote locations in a random order.

A serious situation can arise due to this problem, particularly if the separated animals are to undergo some form of medicament or other process e.g. artificial insemination, as if the wrong animal is included in this sub-group then this animal may be:

inseminated at the wrong point within the oestral cycle, or

may even be overdosed with a medicament, or

be given the wrong medicament altogether, etc.

Another problem associated with these systems is that due to their inadequacies it is still required that an operator checks each animal that has been separated in order to ensure that the correct animals are present and that there are no additional animals or any animals missing. This not only takes additional time and resources but also reduces the operator's confidence in the abilities of the system as the system cannot be relied upon to automatically sort the animals correctly 100% of the time.

A further significant problem associated with all the current systems is that they can only process one animal at a time, therefore the first animal must have triggered/completed the desired operation prior to the next animal being processed by the control unit.

In applications where the required action is located at a distance from the animal identification unit this will cause serious hold-ups and in most cases would prove to be unworkable.

The controlling of animals has wide applications in the animal husbandry industry, drafting is merely a well known application used here as an example only.

The background art has drawn in detail on animal drafting systems as this is the only prior art area known to the applicant which has an animal system or operation automatically functioning in response to an animal identification and, as can be seen still has a number of limitations.

It should be appreciated however that this is only one avenue in which the present invention can be used and is not to be taken as the most important utilisation of the invention.

Another common requirement is to identify individual animals within a milking parlour to ensure that each animal receives the appropriate amount of feed and/or oral treatments.

The milk from some animals has to be withheld as stated previously, due to the presence of medicaments, pathogens or any other unwanted entity within the animal's milk.

At present this is generally done manually which is both time consuming for the operator and can result in misidentification of an animal which could result in the contamination of a batch of milk or in an animal receiving not only the wrong amount of feed but also in some cases perhaps the wrong medicaments.

It is often required, particularly for the oestral cycle of animals, to maintain a historical chart of particular parameters from each animal within a herd in order to ascertain the appropriate time for performing certain functions.

Once again this is not only time consuming but also quite difficult to ensure high accuracy and therefore it is highly desired that there be any form of automatic means for undertaking these tasks.

Due to the time and cost elements involved in the various sorting or controlling processes it would be desired to have a system that is fully automatic and reliable and that can handle a reasonable animal flow rate through the system.

Therefore a system that can correctly identify each individual animal and that can determine which are the desired functions to be undertaken to or on each animal, either locally or remotely, is highly desired.

Not only would the correct identification of each animal at various points within a farm complex speed up the overall processes, this would also improve the overall efficiency and cost benefits to the operator and will also ensure that the animals always get the appropriate treatment, food, etc.

Most other aspects of animal/herd control are almost always undertaken manually and therefore there is no relevant prior art for even the most basic automation of these functions.

The only biological control that can be argued to involve any form of automation is the use of a bolus to deliver substances in a controlled manner to the animal over a period of time.

It should be noted however that these devices/systems do not involve any form of “around-the-loop” decision making and they are just slow-release delivery devices.

Thus, these devices operate independently of any parameters relating to the animal such as ID, medical history, current medical status and so forth. Once the device has been inserted, there is no means by which its operation can be controlled or tailored to the animal's constantly changing needs.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to a further aspect of the present invention there is provided an animal control system, including

at least one transducer assembly intimately associated with an animal, and

at least one control unit, wherein the control unit contains at least one assembly that includes on-board data, and

the control unit is configured to

a) receive data from the transducer assembly, and

b) assess the received data with respect to the on-board data, and

c) formulate and transmit a command to an appropriate transducer assembly the system characterised in that

the control unit is functionally separated both from the actuation of the command and from the transducer assembly or assemblies.

According to another aspect of the present invention there is provided a method of operating an animal control system including:
a) transmitting identifying information from an animal to a control unit, and
b) assessing the identifying information against the control units on-board data, and
c) formulating an appropriate response, and
d) transmitting the response containing a command to an appropriate transducer assembly

characterised by the step of

functionally separating the control unit from the actuation of the command and from the transducer assembly or assemblies.

It should also be appreciated that throughout the present specification the terms “functionally separate” and “functionally separating” should be understood to mean “separate from the function of” but not necessary physically separate.

In one embodiment, the control unit capable of making decisions for an animal could actually be mounted on the animal. However, in preferred embodiments the information is transmitted from the animal and the commands transferred back onto the animal to take effect.

It is envisaged that the control unit and the transducer assembly or assemblies function would be separate in that they would communicate with each other by sending each other messages, but not directly alter each other's data or memory. Thus, the control unit could be functionally separate from the transducers, but perhaps even run on the same microprocessor. Thereby the control unit and transducers are functionally separate with individual software entities.

It is envisaged that the control unit and the actuators are actually separated by a complex decision making process. Therefore, this is intended to be encapsulated by the term “functionally separate”.

It should also be appreciated that throughout the present specification that the term “transducer assembly” should be understood to mean any transducer that can be permanently or temporarily affixed at a point where it is desirable for a decision to be made with respect to an animal. This may be a transducer intimately associated with an animal or dissociated from the animal.

It should be appreciated that throughout the current specification the term “transducer assembly intimately associated with an animal” should be understood to mean items that can send and or receive data. These can include items such as an ear tag, ruminal bolus, intravaginal bolus, subcutaneous transceivers, or any other suitable device that can be inserted in or attached to an animal. Throughout the present specification these items will now be referred to as an “on-animal transducer” or an “actuator assembly”.

Examples of transducer or actuator assemblies disassociated from an animal can include a local or remotely operated drafting system, within a milking stall to identify which animal is in which stall, at the entry or exit of the yards or buildings or any other point where the egress of animals is required to be controlled or the condition of an animal is to be monitored or adjusted and throughout the present specification will now be referred to as an “off-animal transducer”.

Reference throughout this specification to off-animal transducers or actuators assemblies should be understood by those skilled in the art to refer to any components, elements or devices which can be commanded or operated by the control unit in conjunction with the present invention. Such transducers or assemblies may be controlled by the control unit depending on the data received by the control unit. Various different applications and examples of such assemblies will be apparent to those skilled in the art and as such will not be referred to in detail throughout this specification. For example, medication release control systems, automated animal milking machines, automatic animal drafting systems or any other types of actuator systems may be employed in conjunction with the present invention.

Some possible routes of information flow to the control unit are as follows;

on-line or off-line sensing of animal excretions (blood, milk, breath, hair, urine, faeces, sweat),

image recognition (e.g. digital camera acquired image of a whole cow or part of a cow (e.g. iris or retina for identification) and/or relation to the orientation with its surroundings or other animals,

wireless transmission, infrared, inductive, capacitive, electromagnetic, radio signal, acoustic, or other means,

any other farm system

Also throughout the present specification the term “control unit” should be understood to mean an assembly that is capable of storing data in an associated memory assembly and assessing an input signal with respect to the data stored in the memory and completing the appropriate decision making in order that the output from the central control unit will contain the appropriate control function with regard to the input that was assessed. Such control units may be located at any desirable position or point, be it of a fixed location within or on a structure or alternatively mounted within or on an animal to be controlled in conjunction with the present invention.

Examples of received and/or on board data may include the following;
Individual animal data from on-animal sensors (e.g. current body temperature, sweat, intravaginally located mucus conductivity, pedometer/RFID tag).
Individual animal data from on-line milking machine sensors (e.g. current milk conductivity).
Pooled animal data (e.g. average herd inter-cow spacing).
Historical individual animal data (e.g. average animal activity in steps per hour from last ten days, off-line herd testing milk fat percentage—herd testing).
Historical pooled animal data (e.g. average herd milk yield over last 3 milkings).
Environmental data (e.g. ambient temperature and pressure from a weather station or internet information service).
Human originated observations (e.g. noted oestrus behaviour).
Machine originated observations (e.g. noted image recognition from video camera, infra-red detector).
Human originated requests (e.g. safety override command of highest precedence to inhibit drug delivery or to immediately release a drug such as a general anaesthetic).

Further data used by the present invention may include:
type of diet, quantity of feed, water intake, wind speed, wind direction, global positioning system (GPS) co-ordinates, pressure, humidity, age, weight, calving history, general condition, day of oestrous cycle, output from acoustic, vibration, accelerometer and light sensors.
On-line or off-line analysis of blood, milk, breath, hair, urine, faeces, sweat.
Digital camera acquired images of whole animal or part of animal (e.g. iris or retina) and/or relation to an orientation with surroundings and other animals.
Electrical-resistance of genital tissues and vaginal mucus.
Glucose, hormone and pH levels.
Milk fat, lactate, progesterone, somatic cell count, conductivity, yield and temperature levels.
Mounting behaviour, posture (angle of lying or standing), motion, and activity.

This and any other relevant data in preferred embodiments can be recorded in a database and made available for on-line queries. Historical values from such a database can be another source of input.

It is envisaged that within most preferred embodiments of the present invention the control unit may be in the form of a computer system or a system that utilises a dedicated micro-controller.

It should be noted however that this should not be seen to be a limitation on the present invention in any way as in other embodiments the control unit can be any device capable of performing the required functions.

It is envisaged that in most preferred embodiments of the present invention the on-board data may be stored within a memory assembly, such as a computer hard drive, disc array, read only memory (ROM), or any other storage device that is capable of being interrogated in a reasonably short access time.

In preferred embodiments of the present invention the end result of a command from the control unit being received by an on-animal transducer or actuator assembly may be to elicit a biological response on the animal.

The command generated by the control unit could be sent to the appropriate on-animal transducer or to an off-animal transducer, or to both.

As an example commands may be carried out using the following procedure;

the control unit assesses the received data and forms a command containing the instructions for implementing the appropriate response,

the command is transmitted to an on-animal transducer,

the on-animal transducer verifies the command and carries out the command in the manner dictated by the control unit.

It should be appreciated that the absence of a transmitted signal could also be taken as an intended action, for example, if an on-animal transducer were to operate according to a pre-programmed dosage pattern the absence of an “emergency stop” command from the control unit means that the dosage should continue.

In some preferred embodiments of the present invention the control unit input may be fitted in a passageway, such as a drafting race or milking shed, in order that the input can interact with each passing animal's sensor.

This should also not be seen to be a limitation on the present invention in any way as it is equally feasible for the input to be in other locations, examples of which could be a gateway or in a reasonable proximity to a point where a number of animals pass by.

One example of an off-animal transducer would be an automatic pour-on drenching machine.

The control unit may decide that a particular animal should be dosed,

it adds the ID number for that animal for the list of animals to be dosed,

only those animals on that list receive a dose when they next pass through the automated pour on drenching machine.

A command could be carried out by means of an automatic drafting gate in conjunction with an animal ID.

One example of this could be;

an animal whose historically altering weight is exhibiting an abnormal trend is directed to a special paddock to alter its diet.

Another example of a command could be by recognising an animal and dispensing medicated feed or a set value of feed.

In one embodiment of the present invention it can be used in conjunction with the Merlin™ Milking robot (from Fullwood) which can sense an individual animal by its ID and then operate an automatic drafting gate.

Other examples of on-animal transducers include a bolus for variable-rate drug delivery with an intravaginally, or ruminally, located dispenser; electric shock devices; sampling mechanisms for blood, breath etc.

Other examples of off-animal transducers include electric fence controllers; valves; back scratchers; ventilation controls; a locally or remotely operated drafting system; relays and interfaces with other farm systems.

It is expected that in most embodiments of the present invention the animal control system may be permanently installed in its required location, however it should also be appreciated that in some embodiments a temporary or mobile control system may be set up for use in various locations.

Examples of this may include large farms etc wherein not all the animals inhabit the same locations and therefore the present invention can be moved to various locations in order to ensure that all animals are assessed and undergo the appropriate responses to that assessment.

In some preferred embodiments of the present invention the command (or commands) received from the control unit may be such that they either enact, cessate or inhibit a future programmed controlled release of a substance from a device connected to the on-animal transducer, the release of the substance may be over a predetermined period of time or may be in one or more specific bursts of substance release.

One of the main areas that will prove advantageous to the farmer is in the control of the oestral cycle of a number of animals and in identifying the optimum time for these animals to be inseminated.

This should not be taken to be a limitation on the present invention in any way as in other embodiments the substance released can be substances such as medicaments wherein it is desired to control the release of a number of doses of medicament over a period of time.

Those skilled in the art should appreciate that reference to the controlled release of a substance from the device should not be considered as only application for the present invention. Various other types of devices may be activated controlled, or have their behaviour modified by commands received from a control unit employed in conjunction with the present invention.

Furthermore, the present invention should not necessarily be considered as only a mechanism by which the release of medications can be controlled. For example, in one alternative embodiment, the control system may be associated with a device used to deliver anaesthetic to an animal in a controlled manner. Commands from the control unit employed may selectively or on demand anaesthetise the animal involved. Furthermore, in an alternative embodiment of the present invention may be used with wild animal populations to maintain and control population numbers. If for example, a predator/prey relationship exists for two or more species of rare or valued animal, the population of each species may be controlled with use of the present invention.

It should be appreciated that throughout the present specification the term “medicament” should be understood to mean a substance used for medical treatment.

This has particular application to antibiotics wherein the animal will not need to be overly stressed by being contained and dosed several times during the course of antibiotics, as with the present invention once the sensor and medicaments have been either inserted into (or attached to) the animal then the doses can be controlled without needing to physically contact the animal again.

Other substances that may be used are those that improve the medical wellbeing of an animal, this can include trace elements, vitamins etc.

In some preferred embodiments of the present invention the volume of substance released may be adjusted if desired by the control systems commands.

This may include a “delayed-activation” signal which configures the initiation of a release, and/or cessation, and/or inhibition of future programmed release, of the substance, dependent upon the completion of a preset time delay or the completion of preset parameters or requirements—such as the receipt of the needed signal from other sensors within the system,

examples of this could be:

when the animal's temperature reaches a required level, the animal is in a required location, another monitored parameter of the animal reaches a required level, or when the required conditions laid out by the control system are achieved for the device to be activated/deactivated/adjusted.

From the foregoing description it can be clearly seen that the present invention has many significant advantages over the prior art.

One advantage is that the control unit does not have to wait for the command to be enacted before it can process a subsequent animal, giving a far greater throughput of animals. This not only improves the overall efficiency of the operation but also reduces the costs.

Another advantage of the present invention is that since the command is directly associated with an individual animal's identification the operator can have 100% confidence that the sorting of animals will be correct and that the correct command is enacted for each individual animal.

This not only reduces the need for additional personnel or time to check each animal individually, but also reduces the costs associated with feed and/or medicaments as there will be no overfeeding or underfeeding of animals and the operator is ensured that each animal that receives some form of medicinal treatment receives the correct dosage.

Another advantage associated with this is that each individual animal can be maintained at its optimum performance and health and will not undergo any unnecessary stress due to it receiving a wrong treatment etc.

A further advantage associated with the present invention is that where the present invention is being used to monitor and/or control the oestral cycle of a group of animals, the artificial insemination process will have a higher hit rate as only the animals at the correct point of the oestral cycle will be separated for artificial insemination.

Another huge advantage associated with the present invention is that in instances where equipment such as milking robots are being utilised the whole system can be automated therefore further reducing the overheads of the operation and improving the overall efficiency as there will be no time delays due to an operator being distracted by another task such as identifying each animal and ensuring it is processed correctly.

### BRIEF DESCRIPTION OF DRAWINGS

Further aspects of the present invention will become apparent from the following description which is given by way of example only and with reference to the accompanying drawings in which:

FIG. 1 is a diagrammatical representation of one preferred embodiment of the present invention.

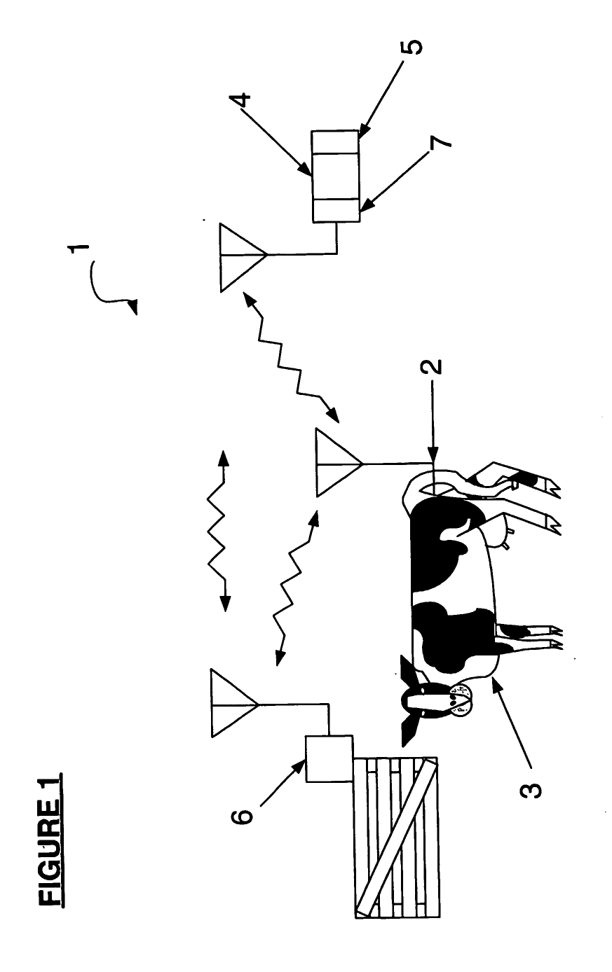

FIG. 2 is a diagrammatical representation of one preferred embodiment of the present invention showing the “around the loop” feature.

FIG. 3 shows a further diagrammatic representation of another embodiment of the present invention again showing the “around the loop” feature discussed with respect to FIG. 2.

### BEST MODES FOR CARRYING OUT THE INVENTION

With reference to the figures there is illustrated an example of an animal control system generally indicated by arrow 1.

The animal control system (1) includes a number of on-animal transducers (2). The on-animal transducers (2) used are generally in the form of a bolus, ear tag or subcutaneous device.

When an animal (3) approaches within range of the animal control system's (1) control unit (4) data is sent from the on-animal transducer (2) to the control unit (4). The control unit (4) assesses the data and identifies the particular animal (3) as the data will contain a unique identifier for each animal (3).

Having identified the animal (3) the control unit (4) then assesses the data and can if necessary make reference to historical data for any preset limit or parameters that are stored in the memory assembly (5).

Once the data has been fully assessed by the control unit (4), the control unit (4) formulates an appropriate response to the data and this response is then transmitted to the appropriate transducer (be that the on-animal transducer (2) or an off-animal transducer (6)). In some situations the response signal is transmitted to more than one transducer.

The following text refers to an example for a cow where it is desired to control the onset of oestrus in order to improve the hit rate for artificial insemination.

The cow (3) is affixed with a vaginal bolus that contains an on-animal transducer (2) which transmits information to the control unit (4), either at preset time intervals or each time the animal passes within range of the control units' transceiver (7).

The control unit (4) will identify the particular cow (3) then assess the received data against the historical data on that particular animal that is contained within the memory assembly (5) of the control unit (4).

Once that particular cow (3) transmits data that indicates the correct time for initiating the release of a hormone from the animal sensor has arrived or is approaching then the control unit (4) will formulate the appropriate command and transmit this command to the on-animal transducer (2) which will then carry out the command by initiating the release of the hormone from the bolus or by priming a delay period at the end of which the hormone release will be initiated.

The control unit (4) can also signal an off-animal transducer (6) affixed to a piece of farm equipment such as a gate so that when the identified cow (3) approaches the off-animal transducer (6) then the gate position will change i.e. from closed to open or from open to closed so as to ensure that the identified cow (3) is contained within a particular location so that the operator of the animal control system (1) can clearly identify in which animals the hormone release has been initiated.

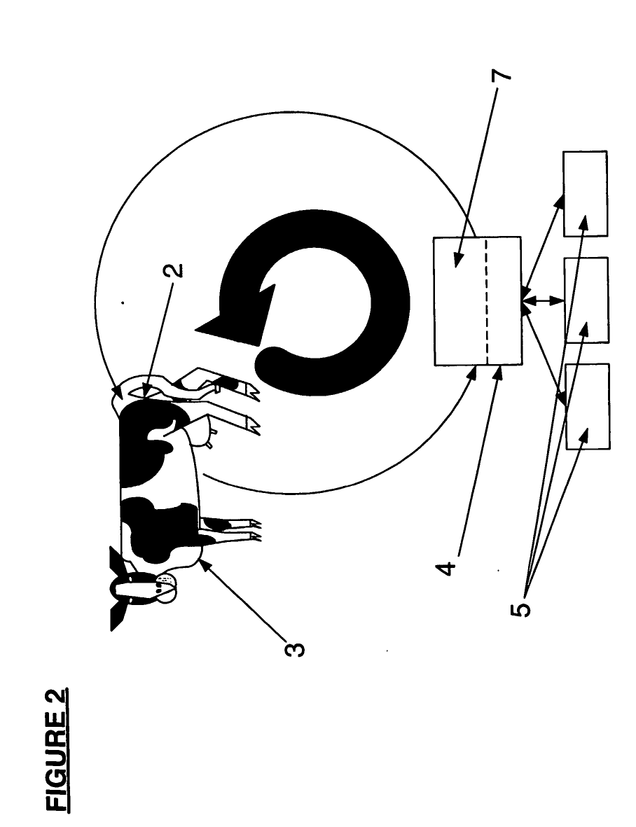

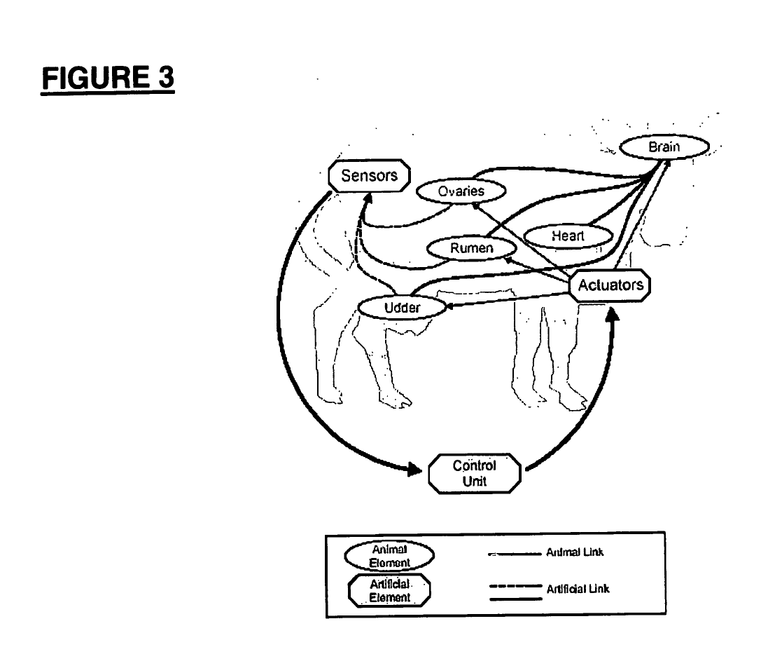

FIG. 3 shows a further diagrammatic representation of another embodiment of the present invention again showing the “around the loop” feature discussed with respect to FIG. 2.

In the example shown a plurality of sensors are provided in conjunction with a plurality of actuators. One interpretation of this system is a multiple-input, multiple-output control system. The animal's natural control/feedback system is enhanced by the addition of artificial sensors, actuators and control unit. The animal and artificial systems operate in parallel, providing a more useful system compared to an animal without the presence of the artificial elements.

The artificial control unit contains a partial model of the animal's natural control, transducer and process transfer functions, allowing it work with the animal when possible. This creates a hybrid synchronised animal/artificial control mechanism, rather than having the two systems constantly in opposition.

Aspects of the present invention have been described by way of example only and it should be appreciated that modifications and additions may be made thereto without departing from the scope thereof as defined in the appended claims.

1-18. (canceled)

19. An animal control system, including at least one transducer assembly physically associated with an animal, said transducer assembly being adapted to transmit individual animal data, and at least one control unit, wherein the control unit contains at least one assembly that includes on-board data, and the control unit is configured to
a) receive individual animal data from the transducer assembly, and
b) assess the received individual animal data with respect to historical individual animal data stored as on-board data in the control unit, and
c) formulate and transmit a command to an appropriate transducer assembly intimately associated with the animal using the historical individual animal data of the animal associated with the transducer assembly.
wherein the control unit is functionally separated from both the actuation of the command and from the transducer assembly or assemblies.

20. An animal control system as claimed in claim 19 wherein at least one of the at least one transducer assembly intimately associated with the animal includes a bolus.

21. An animal control system as claimed in either claim 19 wherein the at least one transducer assembly intimately associated with the animal includes an ear tag.

22. An animal control system as claimed in claim 19 wherein the at least one transducer assembly intimately associated with the animal includes the at least one subcutaneous transceiver.

23. An animal control system as claimed in claim 22 wherein the at least one transducer assembly intimately associated with the animal includes a medication release control system.

24. An animal control system as claimed in claim 19 wherein an information flow to the control unit is via on-line or off-line sensors of animal excretions.

25. An animal control system as claimed in claim 19 wherein a route of information flow to the control unit includes image recognition.

26. An animal control system as claimed in claim 19 wherein a route of information flow to the control unit includes wireless transmission.

27. An animal control system as claimed in claim 19 wherein the end result of the command from the control unit being received by the at least one transducer intimately associated with an animal is to elicit a biological response from the animal.

28. An animal control system as claimed in claim 19 wherein the absence of a transmitted signal is taken as intended action by the transducer assembly or assemblies.

29. An animal control system as claimed in claim 19 wherein the control unit is fitted in a passageway.

30. An animal control system as claimed in claim 19 wherein the control unit is capable of sending instructions to an automatic drafting gate.

31. An animal control system as claimed in claim 19 wherein the control unit is capable of sending instructions to dispense feed.

32. An animal control system as claimed in claim 19 wherein a command from the control unit triggers the dispensing of a substance internally to the animal.

33. An animal control system as claimed in claim 19 wherein a command from the control system includes a delayed activation signal.

34. A method of operating the animal control system including
a) transmitting identity information and individual animal data from an animal to a control unit, and
b) assessing the identity information against the control unit's on-board data, and
c) formulating an appropriate response using historical individual on-board animal data for said animal, and
d) transmitting the response containing a command to an appropriate transducer assembly physically associated with said animal.
wherein the control unit is functionally separated from both the actuation of the command and from the transducer assembly or assemblies.
